(19) United States
(12) Patent Application Publication
(10) Pub. No.: US 2010/0056273 A1
(43) Pub. Date: Mar. 4, 2010

(54) EXTENSIBLE SYSTEM FOR CUSTOMIZED AVATARS AND ACCESSORIES

(75) Inventors: Brendan Reville, Seattle, WA (US); Stacey Law, Redmond, WA (US); Derek Smith, Snohomish, WA (US); Thomas Langan, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/204,036

(22) Filed: Sep. 4, 2008

(51) Int. Cl. G06F 17/00

(52) U.S. Cl. 463/31; 463/42; 463/44

(57) ABSTRACT

An item can be added to an avatar associated with a user of a video game console. The item is represented by a data entry that is written to a manifest, which contains data fields storing a type and a name of the item. Items can be applied to or “worn” by an avatar by setting a flag in the corresponding data entry in the manifest. Items can be obtained from a number of sources, including, for example, disc based games and a server connected to the video game console. Further, items can be obtained as a reward for attaining achievements in a game.

### COPYRIGHT NOTICE AND PERMISSION

A portion of the disclosure of this document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2008 Microsoft Corp.

### FIELD OF TECHNOLOGY

The presently disclosed subject matter relates to the field of computing, and more particularly, to fields such as gaming, although this is merely an exemplary and non-limiting field.

### BACKGROUND

Video game systems sometimes feature two-dimensional or three-dimensional representations of users known as avatars. An avatar can represent a user in a variety of contexts, including computer or video games, applications, chats, forums, communities, and instant messaging services. An avatar can be thought of as an object representing the embodiment of a user and may represent various actions and aspects of the user's personal, beliefs, interests, or social status.

Some avatars can be customized by the user in a variety of ways relating to the appearance of the avatar. For example, in some video game systems, the user can customize the facial features, hair style, skin tone, body build, clothing, and accessories of the avatar. As a particular example, the WII® video gaming system, available from Nintendo of America headquartered in Redmond, Wash., features a user-created, system-wide avatar known as the MII®, which a user may use as his or her user-controlled character in video games that support this feature, such as WII SPORTS®. However, the current system-wide MII® avatars have a pre-defined set of clothing and accessory options, which are collectively referred to as “items” in this disclosure. That is, while the user can customize his or her avatar to some extent, the set of items that can be added to an avatar is limited to those items that are defined when the video gaming system was manufactured.

There do exist mechanisms to introduce new items in game-specific online video game systems. For example, the WORLD OF WARCRAFT® video game, available from Blizzard Entertainment, Inc., of Irvine, Calif., allows new items to be introduced for users to place on their avatars. However, this functionality is limited to a single game—the user cannot use such items in another game or outside the context of the game. Further, there is only one source of new items, namely, Blizzard Entertainment, Inc.

Accordingly, a need continues to exist for an improved avatar system that allows a greater degree of customization of avatars by adding items.

### SUMMARY

According to various embodiments, an item can be added to an avatar associated with a user of a video game console. The item is represented by a data entry that is written to a manifest, which contains data fields storing a type and a name of the item. Items can be applied to or “worn” by an avatar by setting a flag in the corresponding data entry in the manifest. Items can be obtained from a number of sources, including, for example, disc based games and a server connected to the video game console. Further, items can be obtained as a reward for attaining achievements in a game.

One embodiment is directed to a method for adding an item to an avatar associated with a user of a video game console comprising a memory device. A data entry representing the item is added to a manifest stored on the memory device. The manifest contains a first data field identifying a type of the item, a second data field comprising a name of the item, and a flag indicating whether the item is applied to the avatar. It is then determined whether the user wishes to apply the item to the avatar. If so, the flag is set to indicate that the item is applied to the avatar. This method may be performed by a computer executing instructions stored on a computer readable storage medium.

Another embodiment is directed to a system for adding an item to an avatar associated with a user of the system. The system comprises a memory device and a processor. The processor is configured to store on the memory device a data package comprising a representation of the item, at least one bitmapped texture for the item, and information regarding a location on the avatar with which the item is associated . The processor is also configured to add a data entry representing the item to a manifest stored on the memory device. The manifest contains a first data field identifying a type of the item, a second data field comprising a name of the item, and a flag indicating whether the item is applied to the avatar. The processor is configured to determine whether the user wishes to apply the item to the avatar. If so, then the processor sets the flag to indicate that the item is applied to the avatar.

Various embodiments may realize certain advantages. For example, providing an extensible avatar system may enhance the overall gaming experience by allowing users a greater degree of customization of their avatars. In addition, offering items on disc-based games and movies may provide an incentive to purchase discs, thereby increasing revenue.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 is a block diagram representing an exemplary computing device.

FIG. 2 is a block diagram illustrating an implementation of the computing device of FIG. 1 as a game console.

FIG. 3 is a block diagram illustrating an extensible avatar system according to one embodiment.

FIG. 4 is a flow diagram illustrating an example method according to one embodiment.

FIG. 5 is a flow diagram illustrating another example method according to another embodiment.

FIG. 6 is a flow diagram illustrating yet another example method according to yet another embodiment.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

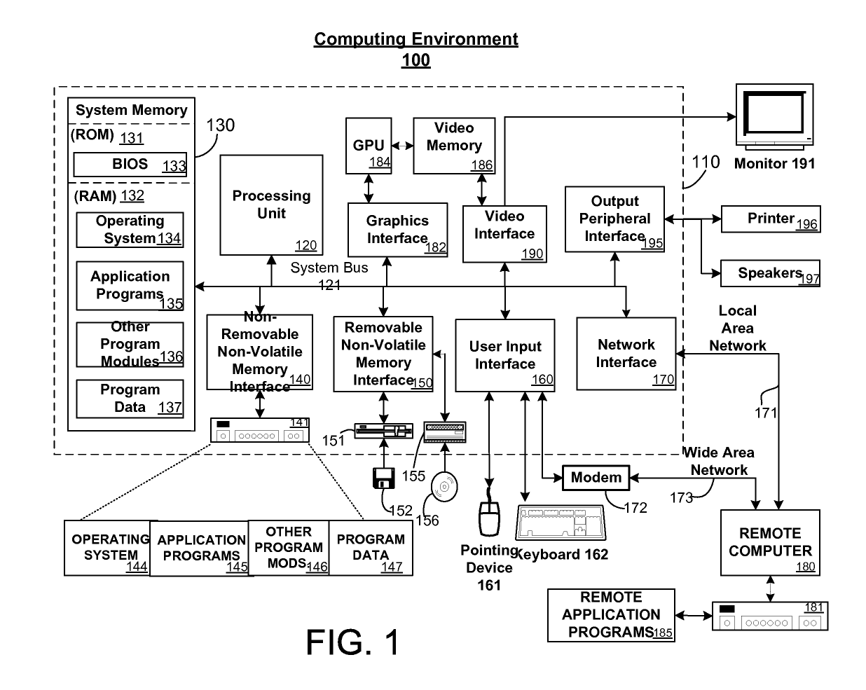

FIG. 1 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 1, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

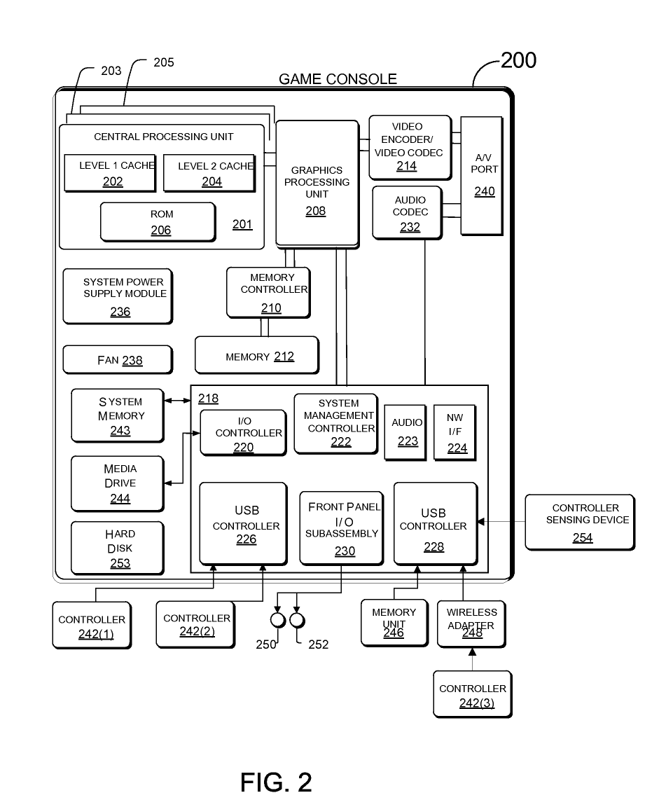

It will be appreciated that one particular application of computer 110 is in the form of a game console 200 as depicted in FIG. 2. As seen therein, game console 200 has a central processing unit (CPU) 201 having a level 1 (L1) cache 202, a level 2 (L2) cache 204, and a flash ROM (Read-Only Memory) 206. The level 1 cache 202 and level 2 cache 204 temporarily store data and hence reduce the number of memory access cycles, thereby improving processing speed and throughput. The flash ROM 206 can store executable code that is loaded during an initial phase of a boot process when the game console 200 is initially powered. Alternatively, the executable code that is loaded during the initial boot phase can be stored in a flash memory device (not shown). Further, the flash ROM 206 can be located separate from CPU 201. Game console 200 can, optionally, be a multi-processor system; for example, game console 200 can have three processors 201, 203, and 205, where processors 203 and 205 have similar or identical components to the CPU 201.

A graphics processing unit (GPU) 208 and a video encoder/video codec (coder/decoder) 214 form a video processing pipeline for high speed and high resolution graphics processing. Data is carried from the graphics processing unit 208 to the video encoder/video codec 214 via a bus. The video processing pipeline outputs data to an A/V (audio/video) port 240 for transmission to a television or other display device. A memory controller 210 is connected to the GPU 208 and CPU 201 to facilitate processor access to various types of memory 212, such as, but not limited to, a RAM (Random Access Memory).

Game console 200 includes an I/O controller 220, a system management controller 222, an audio processing unit 223, a network interface controller 224, a first USB controller 226, a second USB controller 228 and a front panel I/O subassembly 230 that may be implemented on a module 218. The USB controllers 226 and 228 serve as hosts for peripheral controllers 242(1)-242(2), a wireless adapter 248, and an external memory unit 246 (e.g., flash memory, external CD/DVD ROM drive, removable media, etc.). The network interface 224 and/or wireless adapter 248 provide access to a network (e.g., the Internet, a home network, etc.) and may be any of a wide variety of various wired or wireless interface components including an Ethernet card, a modem, a Bluetooth module, a cable modem, and the like. The game console 200 may be connected to a controller sensing device 254 to sense the position or motion of the peripheral controllers 242(1)-242(2) or other accessories. The controller sensing device may be implemented using, for example, a three-dimensional camera or an ultrasonic triangulation system.

System memory 243 is provided to store application data that is loaded during the boot process. A media drive 244 is provided and may comprise a DVD/CD drive, a hard drive, or a removable media drive, etc. The media drive 244 may be internal or external to the game console 200. When the media drive 244 is a drive or reader for removable media (such as removable optical disks or flash cartridges), then the media drive 244 is an example of an interface onto which (or into which) media are mountable for reading. Application data may be accessed via the media drive 244 for execution, playback, etc. by game console 200. Media drive 244 is connected to the I/O controller 220 via a bus, such as a Serial ATA bus or other high speed connection (e.g., IEEE 3394). While media drive 244 may generally refer to various storage embodiments (e.g., hard disk, removable optical disk drive, etc.), game console 200 may specifically include a hard disk 253, which can be used to store game data.

The system management controller 222 provides a variety of service functions related to assuring availability of the game console 200. The audio processing unit 223 and an audio codec 232 form a corresponding audio processing pipeline with high fidelity, 3D, surround, and stereo audio processing according to aspects of the present subject matter described herein. Audio data is carried between the audio processing unit 223 and the audio codec 232 via a communication link. The audio processing pipeline outputs data to the A/V port 240 for reproduction by an external audio player or device having audio capabilities.

The front panel I/O subassembly 230 supports the functionality of the power button 250 and the eject button 252, as well as any LEDs (light emitting diodes) or other indicators exposed on the outer surface of the game console 200. A system power supply module 236 provides power to the components of the game console 200. A fan 238 cools the circuitry within the game console 200.

The CPU 201, GPU 208, memory controller 210, and various other components within the game console 200 are interconnected via one or more buses, including serial and parallel buses, a memory bus, a peripheral bus, and a processor or local bus using any of a variety of bus architectures.

The game console 200 may be operated as a standalone system by simply connecting the system to a television or other display. In this standalone mode, the game console 200 may allow one or more users to interact with the system, watch movies, listen to music, and the like. However, with the integration of broadband connectivity made available through the network interface 224 or the wireless adapter 248, the game console 200 may further be operated as a participant in a larger network community.

The game console 200 can be used with a variety of controllers 242, such as the controllers 242(1), 242(2), and 242(3) of FIG. 2. In the embodiment shown in FIG. 2, controllers 242(1) and 242(2) are wired controllers that communicate with the game console 200 via the USB controller 226. Controller 242(3) is a wireless controller that communicates with the game console 200 via the wireless adapter 248. According to certain embodiments, one or more of the controllers 242 can be implemented as specialized controllers for playing certain types of games. As a particular example, one or more of the controllers 242 can be implemented as a microphone controller for playing singing and music games.

When the game console 200 is powered on or rebooted, application data can be loaded from the system memory 243 into memory 212 and/or caches 202, 204 and executed on the CPU 201. The game console 200 can present a graphic user interface that provides a consistent user experience when navigating to different media types available on the game console 200. In operation, applications and/or other media contained within the media drive 244 may be launched or played from the media drive 244 to provide additional functionalities to the game console 200.

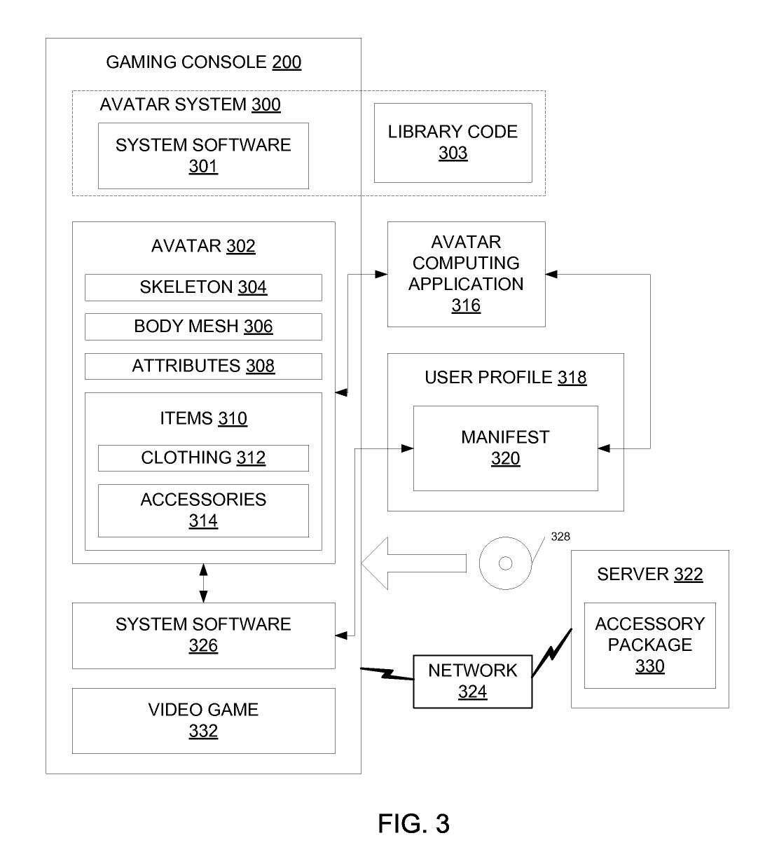

In one embodiment, the application data loaded from the system memory 243 into memory 212 and/or caches 202, 204 and executed on the CPU 201 includes an avatar system 300, illustrated in FIG. 3. The avatar system 300 may be implemented as system software 301, library code 303 available to publishers of video games and other content providers, or as a combination of system software 301 and library code 303, as illustrated by the dashed box in FIG. 3. The avatar system 300 generates an avatar 302 that represents a user in any of a variety of contexts, including, for example, video games, chat or instant messaging applications, forums, communities, and the XBOX LIVE® service.

The avatar system 300 may generate or maintain a three-dimensional “skeleton” 304, a deformable body mesh 306, a set of attributes 308 specifying the appearance of the face and/or body of the avatar 302, and a basic set of items 310, such as clothing 312 and accessories 314. This information may be stored in system software. In addition, video game discs may store packages of assets that define further options for any of these characteristics.

The skeleton 304 may comprise a standardized skeleton that allows avatar computing applications 316, such as video game applications that are designed to incorporate avatars in the context of the game, to move parts of the skeleton 304 at well-defined pivot points. Such avatar computing applications 316 can animate any avatar with only knowledge of the standardized skeleton and without any other specific knowledge about the appearance of the avatar.

In addition to the skeleton, the avatar system 300 may generate or maintain a body mesh 306 that defines the form of the avatar 302, e.g., the height of the avatar 302 and whether the avatar 302 is of a slim, average, or muscular build. The avatar system 300 may also generate or maintain a set of attributes 308 relating to the appearance of the face or body, or both, of the avatar 302. For example, the avatar system 300 may maintain a set of attributes that describe certain aspects of the avatar's face, such as eye color, hair style, coloration, etc.

In some embodiments, the avatar system 300 generates or maintains a basic set of items 310, such as clothing 312 and accessories 314, that can be applied to the avatar 302. For example, the avatar 302 may have handbags, sunglasses, hats, jewelry, and the like. Some items 310 may be applied to the avatar 302, such that the avatar computing application 316 displays the avatar 302 as wearing or using the items 310. Other items 310 may be possessed by the avatar 302, but not applied to the avatar 302. For example, the avatar 302 may possess several different pairs of sunglasses, but can only wear one pair at a time. In other words, the avatar 302 can only have one pair of sunglasses applied at any given time. Items 310 that are possessed by, but not currently applied to, the avatar 302 can be applied to the avatar 302 at a later time. A user profile 318 can store a compact binary manifest 320 that identifies which items 310 are possessed by the avatar 302 and, of those items 310, which are currently applied to the avatar 302. The manifest 320 can be implemented as a data structure comprising a number of fields, including, for example, a field identifying a type of an item (e.g., shirt, glasses, etc.), an item identifier comprising a name of the item, a location identifier that denotes where on the body of the avatar 302 the item is applied, and a flag indicating whether the item is currently applied to the avatar 302. An existing media identifier scheme, e.g., the media identifier scheme used by the XBOX LIVE® service, may be used to represent items. In this way, the avatar system is extensible because items conform to a standardized identification scheme. The items 310 themselves, i.e., graphical representations of the items 310, can be stored either locally, such as on the hard disk 253 of FIG. 2 or on another memory device, or remotely, such as on a server 322 connected to the game console 200 via a network 324, such as the Internet.

The game console 200 also loads system software, known as a closet application 326 that, among other functions, allows the user to apply items 310 to the avatar 302. The closet application 326 may allow the user to “try on” an item 310 on his or her avatar 302 by temporarily applying the item 310 to the avatar 302. In this way, the user can preview the item 310 before committing to purchase or otherwise acquire the item 310.

In addition, according to an aspect of this disclosure, the closet application 326 allows the user to customize the avatar 302 by acquiring new items 310. Unlike some conventional avatar systems in which the set of items that can be applied to an avatar is determined when the game console is manufactured, the avatar system 300 disclosed herein is extensible. In particular, the avatar system 300 allows the user to acquire and apply items 310 that are defined after the game console 200 is manufactured.

Content creators, such as video game publishers, can create items 310 in a three-dimensional editor program. Created items 310 can be stored in a binary file known as an avatar accessory asset package. The avatar accessory asset package may include a three-dimensional mesh, one or more bitmapped textures, and information about where the item 310 is placed on the body of the avatar 302. Because the avatar accessory asset package is comprised of data, video games that have already shipped can still display items 310 that are added after the video game was published.

The avatar accessory asset package may be submitted to the manufacturer of the game console 200, e.g., Microsoft Corporation, for review. For example, the manufacturer of the game console 200 may test the avatar accessory asset package to ensure that it is compatible with the avatar system 300 and does not pose any security risks. In this way, it may be ensured that items created by entities other than the manufacturer of the game console 200 can be integrated throughout various titles and applications. The review process may serve the additional purpose of controlling the creation and consumption of items 310 so as to preserve the value of the items 310. If the avatar accessory asset package passes the review process, it may be digitally signed and made available to users, e.g., using the XBOX LIVE® service.

New items 310 can be acquired in a number of ways. For example, an optical disc 328, such as a video game, a movie DVD, or a DVD-ROM disc, may store an avatar accessory asset package and may provide access to one or more items 310, which may be related to the content of the optical disc 328 and may be offered to promote sales of the optical disc 328. As another example, an avatar accessory asset package that contains one or more items 310 can be downloaded to the game console 200 from the network 324 using, e.g., the XBOX LIVE® service. The XBOX LIVE® service may make the avatar accessory asset package available for download either for free or for purchase in a purchasing experience. As yet another example, a video game application 332 may award an item 310 as a reward for attaining an achievement in the video game.

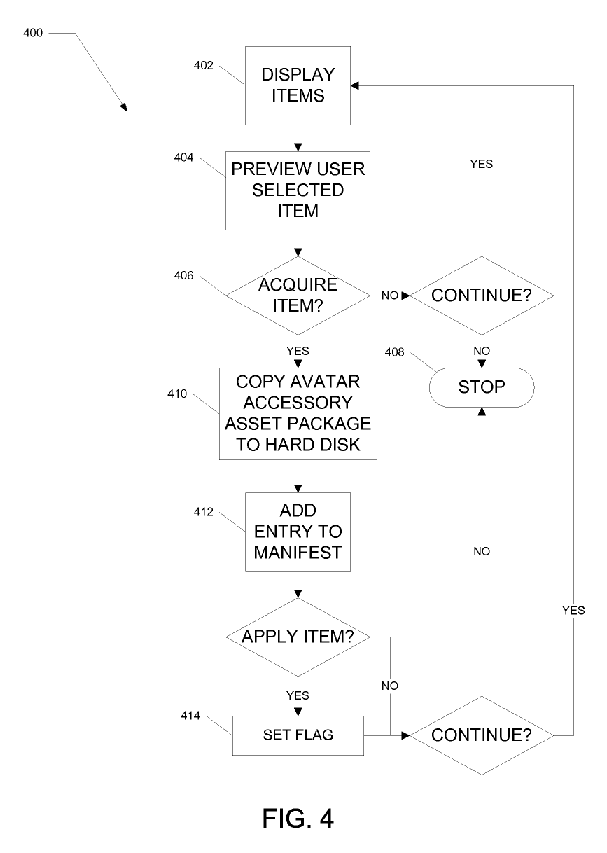

FIG. 4 is a flowchart illustrating an example operational flow 400 for acquiring a new item 310 from the optical disc 328. Those skilled in the art will note that the disclosed process is merely illustrative and that different implementations are contemplated. The operational flow 400 may be triggered in response to the user beginning execution of a video game on the game console 200. For example, the user may power on the game console 200, insert the optical disc 328, and enter an avatar customization mode in a video game that is loaded from the optical disc 328.

At an operation 402, the game console 200 displays a set of items 310 that can be added from the optical disc 328. These items 310 may be related to the content of the optical disc 328. For example, if the optical disc 328 stores a sports video game, some available items 310 may include jerseys or headgear associated with the sport. As another example, if the optical disc 328 stores a movie, some available items 310 may include items that are related to the movie. On the other hand, the items 310 that can be added from the optical disc 328 may be unrelated to the content of the optical disc 328.

At an operation 404, the game console 200 detects a user selection of an available item 310 and allows the user to preview the selected item 310. That is, the game console 200 displays the avatar 302 with the selected item 310 applied, but does not actually apply the selected item 310 to the avatar. The user selection may occur either with actuation of a selection control or without such actuation (e.g., by “rolling over” an item 310 with a screen pointer).

Next, at an operation 406, the game console 200 determines whether the user wishes to acquire the selected item 310. If not, the game console 200 determines whether the user wishes to continue previewing items 310. For example, an “exit” or “back” command may be available to exit the avatar customization mode. Until the “exit” or “back” command is selected, the game console 200 may assume that the user wishes to continue previewing items 310. If the user wishes to continue previewing items 310, the operational flow returns to operation 402. If not, the operational flow stops at an operation 408.

If the user does wish to acquire the selected item 310, then the avatar accessory asset package corresponding to the selected item 310 is copied to the hard disk 253 at an operation 410. The accessory asset package may also be stored in a program memory or other memory rather than a hard disk. In addition, at an operation 412, an entry representing the newly acquired item 310 is added to the manifest 320 to show that the avatar 302 now possesses the item 310.

The game console 200 then determines whether the user wishes to apply the newly acquired item 310 to the avatar 302. If so, then at an operation 414, the game console 200 applies the newly acquired item 310 to the avatar 302, for example, by setting a flag in the manifest 320 to denote that the item 310 is currently applied to the avatar 302. With the item 310 now applied to the avatar 302, the item 310 can be viewed in video games or other contexts other than the one from which the item 310 was acquired. Next, the game console 200 determines whether the user wishes to continue previewing items 310. If the user does wish to continue previewing items 310, the operational flow returns to operation 402. If not, the operational flow stops at operation 408.

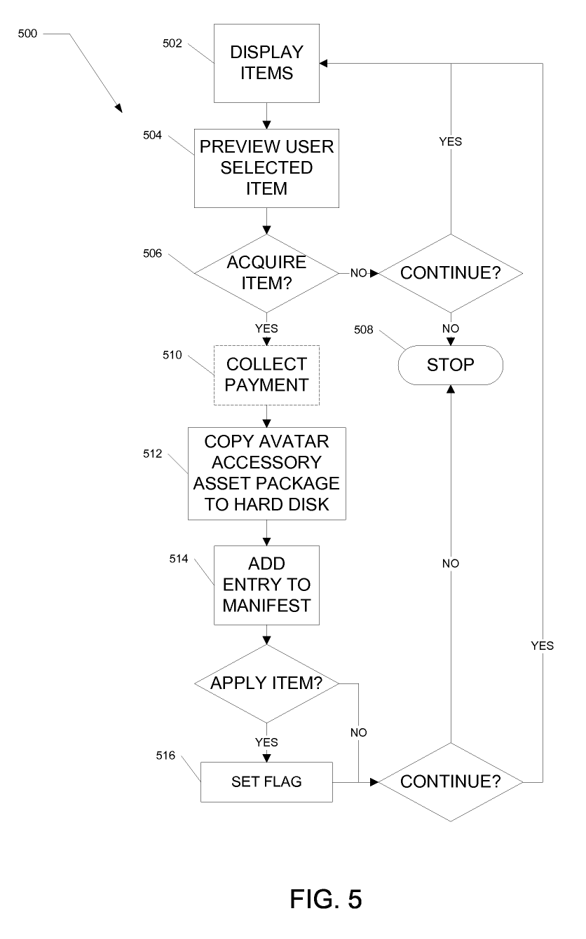

FIG. 5 is a flowchart illustrating an example operational flow 500 for acquiring a new item 310 from the network 324 using the XBOX LIVE® service. Those skilled in the art will note that the disclosed process is merely illustrative and that different implementations are contemplated. The operational flow 500 may be triggered in response to the user selecting an avatar customization mode in the XBOX LIVE® service.

At an operation 502, the game console 200 displays a set of items 310 that can be downloaded from the network 324. Next, at an operation 504, the game console 200 detects a user selection of an item 310 and allows the user to preview the selected item 310 by displaying the avatar 302 with the selected item 310 applied. The user selection may occur either with or without actuation of a selection control. At this point, the game console 200 neither adds an entry to the manifest 320 nor actually applies the item 310 to the avatar 302, as the user has not yet decided to acquire the item 310.

Next, at an operation 506, the game console 200 determines whether the user wishes to acquire the selected item 310. If not, the game console 200 determines whether the user wishes to continue previewing items 310. If so, the operational flow returns to operation 502. If not, the operational flow stops at an operation 508.

If the user does wish to acquire the selected item 310, the game console 200 may collect a payment from the user at an operation 5 10. The payment may be collected either in the form of real world currency (e.g., dollars) or in the form of a proxy for real world currency, such as Microsoft Points. It will be appreciated that operation 510 is optional, as illustrated by the dashed box on FIG. 5. For example, if the selected item 310 is offered free of charge, the game console 200 omits operation 510.

After any required payment is collected from the user, the avatar accessory asset package corresponding to the selected item 310 is copied to the hard disk 253 at an operation 512. The accessory asset package may also be stored in a program memory or other memory rather than a hard disk. In addition, at an operation 514, an entry representing the newly acquired item 310 is added to the manifest 320 to show that the avatar 302 now possesses the item 310.

The game console then determines whether the user wishes to apply the newly acquired item 310 to the avatar 302. If so, then at an operation 516, the game console 200 applies the newly acquired item to the avatar 302, for example, by setting a flag in the manifest 320 to denote that the item 310 is currently applied to the avatar 302. With the item 310 now applied to the avatar 302, the item 310 can be viewed in a variety of video games and other contexts. Next, the game console 200 determines whether the user wishes to continue previewing items 310. If the user does wish to continue previewing items 310, the operational flow returns to operation 502. If not, the operational flow stops at operation 508.

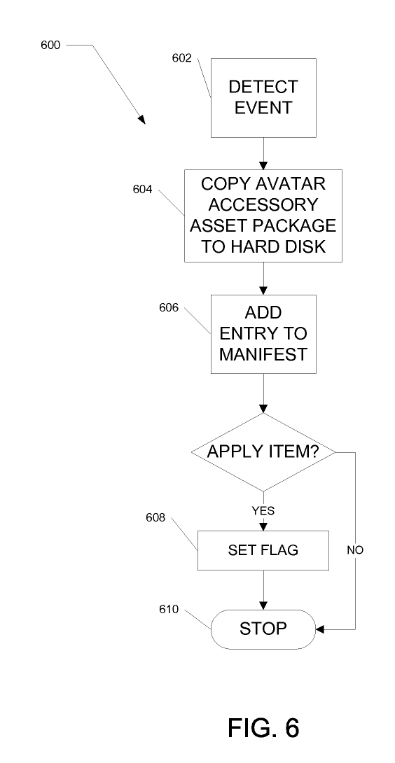

FIG. 6 is a flowchart illustrating an example operational flow 600 for acquiring a new item 310 from the video game application 332. Those skilled in the art will note that the disclosed process is merely illustrative and that different implementations are contemplated. The operational flow 600 may be triggered in response to certain events occurring within a video game. For example, the user may attain a specified achievement, such as attaining a certain score or progressing to a specified point in a storyline. As another example, the user may purchase the item 310 with in-game or real world currency.

At an operation 602, the game console 200 detects the occurrence of an event within the video game, such as the attainment of an achievement. In response to the occurrence of the event, the game console 200 awards the item 310 to the user. While not shown in FIG. 6, the game console 200 may provide the user with the opportunity to accept or reject the item 310. However, the game console 200 may presume that the user would not object to receiving the item 310, as there is no cost, either in game or in the real world, to the user to accept the item 310. Moreover, in the scenario in which the user purchases the item 310 with in-game or real world currency, the act of purchasing the item 310 implies that the user wishes to acquire the item 310, and it is therefore unnecessary to preview the item 310.

To show that the avatar 302 has acquired the item 310, the game console then copies the accessory asset package corresponding to the awarded item 310 to the hard disk 253 at an operation 604. The accessory asset package may also be stored in a program memory or other memory rather than a hard disk. In addition, at an operation 606, an entry representing the newly acquired item 310 is added to the manifest 320 to show that the avatar 302 now possesses the item 310.

The game console 200 may then determine whether the user wishes to apply the newly acquired item 310 to the avatar 302. If so, then at an operation 608, the game console 200 applies the newly acquired item 310 to the avatar 302, for example, by setting a flag in the manifest 320 to denote that the item 310 is currently applied to the avatar 302. With the item 310 now applied to the avatar 302, the item 310 can be viewed in video games or other contexts other than the one from which the item 310 was acquired. It will be appreciated that, in some embodiments, the item 310 may be automatically applied to the avatar 302 without any input from the user. Conversely, in other embodiments, the item 310 is not immediately applied to the avatar 302, but is applied only after the user actively applies the item 310 to the avatar 302, either at the time of acquisition or at some later time. In any event, after the entry representing the newly acquired item 310 is added to the manifest and the item 310 is optionally applied to the avatar 302, the operational flow stops at an operation 610, after which normal gameplay may resume.

While the above embodiments have been described in the context of an avatar system for a video game console, it will be appreciated that the principles described herein can be applied to any of a variety of computing devices, such as desktop or notebook computers.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A method for adding an item to an avatar associated with a user of a video game console comprising a memory device, the method comprising:
adding a data entry representing the item to a manifest stored on the memory device, the manifest comprising a first data field identifying a type of the item, a second data field comprising a name of the item, and a flag indicating whether the item is applied to the avatar;
determining whether the user wishes to apply the item to the avatar; and
if the user wishes to apply the item to the avatar, then setting the flag to indicate that the item is applied to the avatar.

2. The method of claim 1, further comprising storing on the memory device a data package comprising a representation of the item, at least one bitmapped texture for the item, and information regarding a location on the avatar with which the item is associated.

3. The method of claim 2, further comprising retrieving the data package from an optical disc.

4. The method of claim 2, further comprising receiving the data package from a server connected to the video game console via a network.

5. The method of claim 1, further comprising detecting an event occurring within a video game application executed on the video game console.

6. The method of claim 1, further comprising displaying a plurality of available items.

7. The method of claim 6, further comprising displaying at least one of the available items as applied to the avatar and receiving a user selection of one of the displayed available items.

8. A computer readable storage medium storing computer executable commands that, when executed by a computer comprising a memory device, cause the computer to:
add a data entry representing an item to a manifest stored on the memory device, the manifest comprising a first data field identifying a type of the item, a second data field comprising a name of the item, and a flag indicating whether the item is applied to an avatar;
determine whether a user wishes to apply the item to the avatar; and
if the user wishes to apply the item to the avatar, then set the flag to indicate that the item is applied to the avatar.

9. The computer readable storage medium of claim 8, storing further computer executable commands for storing on the memory device a data package comprising a representation of the item, at least one bitmapped texture for the item, and information regarding a location on the avatar with which the item is associated.

10. The computer readable storage medium of claim 9, storing further computer executable commands for receiving the data package from one of an optical disc and a server connected to the computer via a network.

11. The computer readable storage medium of claim 8, storing further computer executable commands for detecting an event occurring within a video game application executed on the computer.

12. The computer readable storage medium of claim 8, storing further computer executable commands for:
displaying a plurality of available items; and
displaying at least one of the available items as applied to the avatar and receiving a user selection of one of the displayed available items.

13. A system for adding an item to an avatar associated with a user of the system, the system comprising:
a memory device; and
a processor configured to
store on the memory device a data package comprising a representation of the item, at least one bitmapped texture for the item, and information regarding a location on the avatar with which the item is associated;
add a data entry representing the item to a manifest stored on the memory device, the manifest comprising a first data field identifying a type of the item, a second data field comprising a name of the item, and a flag indicating whether the item is applied to the avatar;
determine whether the user wishes to apply the item to the avatar; and
if the user wishes to apply the item to the avatar, then set the flag to indicate that the item is applied to the avatar.

14. The system of claim 13, further comprising an optical disc drive, wherein the processor is further configured to receive the data package from an optical disc.

15. The system of claim 13, further comprising a communication device for establishing communication with a network, wherein the processor is further configured to receive the data package from a server connected to the system via a network.

16. The system of claim 13, wherein the system is configured to collect a payment from the user before the processor receives the data package from the server.

17. The system of claim 13, wherein the processor is further configured to detect an event occurring within a video game application executed on the system.

18. The system of claim 17, wherein the event is an achievement attained by the user.

19. The system of claim 13, wherein the processor is further configured to display a plurality of available items.

20. The method of claim 19, wherein the processor is further configured to display at least one of the available items as applied to the avatar and receiving a user selection of one of the displayed available items.
